(19) United States
(12) Patent Application Publication
(10) Pub. No.: US 2015/0198742 A1
(43) Pub. Date: Jul. 16, 2015

(54) OPTICAL FILM, POLARIZING PLATE AND LIQUID CRYSTAL DISPLAY DEVICE

(71) Applicant: FUJIFILM Corporation, Tokyo (JP)

(72) Inventors: Yoshiaki HISAKADO, Kanagawa (JP); Masato NAGURA, Kanagawa (JP); Rikio INOUE, Kanagawa (JP)

(73) Assignee: FUJIFILM Corporation, Tokyo (JP)

(21) Appl. No.: 14/669,747

(22) Filed: Mar. 26, 2015

Related U.S. Application Data
(63) Continuation of application No. PCT/JP2013/073408, filed on Aug. 30, 2013.

(30) Foreign Application Priority Data
Sep. 28, 2012 (JP) 2012-217536
Aug. 27, 2013 (JP) 2013-175677

(51) Int. Cl. G02B 1/04; G02F 1/1335; G02B 5/30; C08L 1/10; G02B 1/14

(52) U.S. Cl. CPC G02B 1/04; C08L 1/10; G02B 1/14; G02B 5/3033; G02F 1/133528

(57) ABSTRACT

There is provided an optical film which is a cellulose acylate film including a cellulose acylate and a sugar ester compound having at least one aromatic group, the film having a film thickness of 15 μm to 35 μm, in which a number density of the aromatic group of the sugar ester compound is 0.90×10⁻³ mol or more and 5.00×10⁻³ mol or less per 1 g of a solid component in the cellulose acylate film.

### CROSS-REFERENCE TO RELATED APPLICATION(S)

This is a continuation of International Application No. PCT/JP2013/073408 filed on Aug. 30, 2013, and claims priority from Japanese Patent Application Nos. 2012-217536 filed on Sep. 28, 2012, and 2013-175677 filed on Aug. 27, 2013, the entire disclosures of which are incorporated herein by reference.

### BACKGROUND

1. Technical Field

The present invention relates to an optical film, a polarizing plate and a liquid crystal display device.

2. Background Art

A recent liquid crystal display device is considered to be used under various severe environments including outdoor, with the use expansion of mobile and the like, and a polarizing plate used in the liquid crystal display device are required to have durability under high temperature and high humidity.

Further, weight lightening and thinning of liquid crystal panels become a trend, and the polarizing plate, furthermore, a protective film for the polarizing film is also required to be thin, but the thinning of the film may have a problem in that reduction in pencil hardness or deterioration of the durability of the polarizing plate using the thin film are easily caused.

Japanese Patent Application Laid-Open No. 2012-031313 discloses a cellulose acylate film containing two kinds of an aromatic sugar ester compound and an aliphatic sugar ester compound, in which a planar failure is reduced, a temporal change of optical characteristic values is reduced, and a temporal change of a polarizing plate is reduced, so that the durability of the polarizing plate may be improved.

### SUMMARY OF INVENTION

In a conventional optical film having a film thickness greater than 35 μm, a problem with film hardness (Knoop hardness and pencil hardness) was immaterial. Thinning causes problems that the film hardness (Knoop hardness and pencil hardness) and the durability of the polarizing plate are remarkably reduced. An object of the present invention is to provide an optical film in which both thinning and hardness of a polarizing plate protective film can be achieved, and durability of the polarizing plate can be improved.

[1] An optical film which is a cellulose acylate film including: a cellulose acylate; and a sugar ester compound containing at least one aromatic group, wherein the cellulose acylate film has a thickness of 15 μm to 35 μm, and a number density of the aromatic group of the sugar ester compound is 0.90×10⁻³ mol or more and 5.00×10⁻³ mol or less per 1 g of a solid component in the cellulose acylate film.

[2] The optical film according to [1], wherein a Knoop hardness is 240 N/mm² or more.

[3] The optical film according to [1] or [2], wherein the sugar ester compound containing at least one aromatic group is represented by formula (1):

(OH)ᵤ-G-(O—R¹)ᵥ(O—R²)_{w} Formula (1)

wherein G represents a sugar residue, R¹ represents a monovalent aromatic group, and R¹ may include a plurality of species of aromatic groups when a plurality of R¹'s is present, R² represents a monovalent aliphatic group, and R² may include a plurality of species of aliphatic groups when a plurality of R²'s is present, and u, v, and w each independently represent an integer, u+v+w is the same as a number of hydroxyl groups when G is a unsubstituted sugar having a cyclic acetal structure, and u and w may be zero, but v is 1 or more.

[4] The optical film according to [3], wherein R¹ represents an acyl group having an aromatic ring.

[5] The optical film according to [3] or [4], wherein R¹ represents a benzoyl group.

[6] The optical film according to any one of [3] to [5], wherein R² represents an aliphatic acyl group.

[7] The optical film according to any one of [3] to [6], wherein R² represents an acetyl group.

[8] The optical film according to any one of [3] to [7], wherein G is a monosaccharide residue, and v is from 2 to 4.

[9] The optical film according to any one of [3] to [7], wherein G is a disaccharide residue, and v is from 2 to 7.

[10] The optical film according to any one of [1] to [9], wherein an amount of the sugar ester compound is 0.16 g to 0.50 g per 1 g of a solid component in the cellulose acylate film.

[11] The optical film according to any one of [1] to [10], wherein an amount of the sugar ester compound is 0.28 g to 0.40 g per 1 g of a solid component in the cellulose acylate film.

[12] The optical film according to any one of [1] to [11], further including an ultraviolet ray absorbent.

[13] A polarizing plate including at least one sheet of the optical film according to any one of [1] to [12].

[14] A liquid crystal display device including the polarizing plate according to [13].

According to the present invention, it is possible is to provide an optical film in which both thinning and hardness (Knoop hardness and pencil hardness) of a polarizing plate protective film can be achieved, and durability of the polarizing plate can be improved.

### DETAILED DESCRIPTION OF EXEMPLARY EMBODIMENTS

[Optical Film]

(Cellulose Acylate)

An optical film of the present invention preferably contains cellulose acylate as a main component. The cellulose acylate used in the present invention is not particularly limited. Among others, cellulose acylate having an acetyl substitution degree of 2.70 to 2.95 is preferably used. If the acetyl substitution degree is 2.7 or more, it is preferred in that the compatibility with a sugar ester compound having at least one aromatic group and the durability of the polarizing plate are excellent.

The acetyl substitution degree of the cellulose acylate is more preferably 2.75 to 2.95, and particularly preferably 2.80 to 2.95.

A preferred range of the total acyl substitution degree is the same as the preferred range of the acetyl substitution degree.

Further, the acyl substitution degree may be measured pursuant to the method as defined in ASTM-D817-96. A moiety, which is not substituted with an acyl group, is usually present as a hydroxyl group.

The acyl group substituted by a hydroxyl group of the cellulose may be an aliphatic group or an allyl group without being particularly limited, and may be used either alone or in a mixture of two or more thereof. Examples thereof may include alkylcarbonyl ester, alkenylcarbonyl ester, aromatic carbonyl ester, or aromatic alkylcarbonyl ester of the cellulose, each of which may have a further substituted group.

Examples of the preferred acyl group may include an acetyl, propionyl, butanoyl, heptanoyl, hexanoyl, octanoyl, decanoyl, dodecanoyl, tridecanoyl, tetradecanoyl, hexadecanoyl, octadecanoyl, iso-butanoyl, t-butanoyl, cyclohexanecarbonyl, oleoyl, benzol, naphthylcarbonyl, cinnamoyl group and the like.

Among them, acetyl, propionyl, butanoyl, dodecanoyl, octadecanoyl, t-butanoyl, oleoyl, benzoyl, naphthylcarbonyl, cinnamoyl and the like are preferred, acetyl, propionyl, and butanoyl arc more preferred, and acetyl is most preferred.

The cellulose acylate used in the present invention is most preferably cellulose acetate, and incidentally preferably cellulose acetate propionate, or cellulose acetate butyrate.

A basic principle of the synthesis of the cellulose acylate is described in Migita, et al. Wood Chemistry, pp. 180 to 190 (KYORITSU SHUPPAN CO., LTD. 1968). A representative synthesis is a liquid-phase acetylation with a carboxylic acid anhydride-acetic acid-sulfuric acid catalyst.

In order to obtain the cellulose acylate, particularly, a cellulose material such s cotton linter or wood pulp is pretreated with an appropriate amount of acetic acid, introduced into a previously cooled carboxylated mixed solution, and esterified to synthesize a complete cellulose acylate (the sum of the acyl substitution degree at the 2-, 3-, and 6-positions is about 3.00). The carboxylated mixed solution generally contains acetic acid as a solvent, anhydrous carboxylic acid as an esterifying agent, and sulfuric acid as a catalyst. The anhydrous carboxylic acid is usually used in a stoichiometrically excess amount, which is greater than the sum of the cellulose reacting therewith and moisture present in the system. After the esterification is completed, an aqueous solution of a neutralizing agent (for example, a carbonate, acetate, or oxide of calcium, magnesium, ion, aluminum, or zinc) is added thereto in order to hydrolize the excess anhydrous carboxylic acid and neutralize a part of the esterification catalyst which are remaining in the system. Then, the obtained cellulose acylate is maintained in the presence of a small amount of the acetylation catalyst (generally, the remaining sulfuric acid) at 50° C. to 90° C. for saponification aging to obtain a solution containing cellulose acylate in which the acyl substitution degree and the polymerization degree are changed to a desired degree (cellulose acylate solution). At the time when the cellulose acylate solution is obtained, the above-mentioned specific cellulose acylate may be obtained by introducing the cellulose acylate solution into water or dilute sulfuric acid (or introducing water or dilute acid into the cellulose acylate solution) with or without completely neutralizing the catalyst remaining in the system to separate the cellulose acylate, and performing cleaning and stabilization treatment.

The molecular weight of the cellulose acylate is preferably 40,000 to 200,000, and more preferably 80,000 to 150,000 as a number average molecular weight.

The cellulose acylate used in the present invention preferably has a Mw/Mn ratio of 4.0 or less, more preferably 1.4 to 3.4.

In the present invention, as for the average molecular weight and the molecular weight distribution of cellulose acylate and the like, a number average molecular weight (Mn) and a weight average molecular weight (Mw) may he calculated using a gel permeation chromatography (GPC) and the ratio thereof may be determined by a method as described in International Publication WO2008-126535.

[Film Thickness of Film]

A range of the film thickness of the cellulose acylate film of the present invention is 15 μm to 35 μm. If the film thickness is 15 μm or more, it is preferred from the viewpoint of suppressing breakage of the film. If the film thickness is 35 μm or less, the effect of the present invention is remarkably exerted. The range of the film thickness is preferably 15 to 30 μm, and particularly preferably 15 to 25 μm.

[Sugar Ester Compound]

The optical film of the present invention includes a sugar ester compound having at least one aromatic group, and a number density of the aromatic group of the sugar ester compound is 0.90×10⁻³ mol to 5.00×10⁻³ mol per 1 g of solid of the cellulose acylate film.

Here, in a case where the optical film includes p kinds of sugar ester compounds having at least one aromatic group, assuming that the sugar ester compounds having at least one aromatic group are C1, C2, . . . Cp (p represents a natural number), the content of the sugar ester compound Cp contained in 1 g of solid of the optical film is Dp (unit: g), the molecular weight of the sugar ester compound Cp is Mp, and the substitution degree of the aromatic group thereof is Np, a number density of the aromatic group is represented by the following equation:

Number density of aromatic group=ΣNp×Dp/Mp (the sum of all p)

[Unit mol/g of Film Solid]

Particularly, in a case where the ester substituents of the sugar ester compounds C1 to Cp are the same species but the ester substitution degrees thereof are different, and the mixture thereof are added, when assuming that the average of the substitution degree Np is Nav, the average of the molecular weight Mp is Mav, and the sum of the contents is D, the equation is represented as follows:

Number density of aromatic group=Nav×D/Mav

[Unit mol/g of Film Solid]

Further, in a case where the sugar ester compound of the present invention is a mixture of compounds having the same species of ester substituents but different ester substitution degree thereof, the average substitution degree Nav and the average molecular weight Mav may be calculated from a ratio of a peak area by measuring the contents of the sugar esters having the respective substitution degrees.

The sugar ester compound having at least aromatic group used in the present invention preferably has a structure represented by the following Formula (1).

(OH)ᵤ-G-(O—R¹)ᵥ(O—R²)_{w} Formula (1)

In Formula (1), G represents a sugar residue, R¹ represents a monovalent aromatic group, also including a case where there is a plurality of species of aromatic groups, R² represents a monovalent aliphatic group also including a case where there is a plurality of species of aliphatic groups, u, v, and w each independently represent an integer, u+v+w is the same as the number of hydroxyl groups when assuming that G is a unsubstituted sugar having a cyclic acetal structure, and u and w may be zero, but v is 1 or more.

The sugar residue G of Formula (1) preferably contains a pyranose structural unit or a furanose structural unit, and is preferably a residue of a monosaccharide compound (A) having one furanose structure or pyranose structure, or a residue of a disaccharide compound (B) in which two of at least one kind of the furanose structure or the pyranose structure are bound.

Examples of the monosaccharide compound (A) may include, but not limited thereto, glucose, galactose, mannose, fructose, xylose, or arabinose.

Examples of the disaccharide compound (B) may include lactose, sucrose, nystose, 1F-fructosylnystose, stachyose, maltitol, lactitol, lactulose, cellobiose, maltose, cellotriose, maltotriose, raffinose, or kestose. Besides, examples thereof may also include, but not limited thereto, gentiobiose, gentiotriose, gentiotetraose, xylotriose, galactosylsucrose and the like.

Among the compound (A) and the compound (B), a compound having both of the furanose structure and the the pyranose structure is particularly preferred. Examples thereof preferably include sucrose, kestose, nystose, 1F-fructosylnystose, stachyose and the like, and more preferably sucrose. Further, for the compound (B), the compound in which two of at least one kind of the furanose structure or the pyranose structure are bound is one of preferred aspects.

In Formula (1), R¹ represents a monovalent aromatic group, and R¹ is preferably an acyl group having an aromatic ring.

Preferred example of the aromatic monocarboxylic acid used when substituted by R¹ may include monocarboxylic acid in which an alkyl group or an alkoxy group is introduced into a benzene ring of benzoic acid or toluic acid, and aromatic monocarboxylic acid having two or more benzene rings such as biphenylcarboxylic acid, naphthalenecarboxylic acid, and teteralincarboxylic acid, more particularly, xylylic acid, hemellitic acid, mesitylenic acid, prehnitylic acid, γ-isodurylic acid, durylic acid, mesitoic acid, α-isodurylic acid, cuminic acid, α-toluic acid, hydratropic acid, atropic acid, hydrocinnamic acid, salicylic acid, o-anisic acid, m-anisic acid, p-anisic acid, creosotic acid, o-homosalicylic acid, m-homosalicylic acid, p-homosalicylic acid, o-pyrocatechuic acid, β-resorcylic acid, vanillic acid, isovanillic acid, eratric acid, o-veratric acid, gallic acid, asaronic acid, mandelic acid, homoanisic acid, homovanillic acid, homoveratric acid, o-homoveratric acid, phthalonic acid, and p-cumaric acid, and particularly preferably benzoic acid.

That is, it is preferred that R¹ in Formula (1) represents a benzoyl group.

In Formula (1), R¹ represents a monovalent aliphatic group, and R¹ is preferably an aliphatic acyl group.

Preferred example of the aliphatic monocarboxylic acid used when substituted by R² may include saturated fatty acid such as acetic acid, propionic acid, butyric acid, isobutyric acid, valeric acid, caproic acid, enanthic acid, caprylic acid, pelagonic acid, capric acid, 2-ethyl-hexanecarboxylic acid, undecylic acid, lauric acid, tridecylic acid, myristic acid, pentadecylic acid, palmitic acid, heptadecylic acid, stearic acid, nonadecanoic acid, arachic acid, behenic acid, lignoceric acid, cerotic acid, heptacosanoic acid, montanic acid, melissic acid, and lacceric acid; and unsaturated fatty acid such as undecylenic acid, oleic acid, sorbic acid, linoleic acid, linolenic acid, arachidonic acid, and octenoic acid; and particularly preferably one which is substituted with acetic acid.

That is, it is preferred that R² in Formula (1) represents an acetyl group.

In Formula (1), when G is a monosaccharide residue, it is preferred that u+v+w is 5, and v, which represents the number of substitution of aromatic groups, is 2 to 4. u is preferably 1 to 3. w is preferably 0 to 2, and more preferably 0.

Further, in Formula (1), when G is a disaccharide residue, it is preferred that u+v+w is 8, and v, which represents the number of substitution of aromatic groups, is 2 to 7, and more preferably 3 to 6. u is preferably 1 to 6, and more preferably 2 to 5. w is preferably 0 to 2, and more preferably 0.

When the sugar ester compound of the present invention is a mixture of compounds having the same species of ester substituents but different ester substitution degree thereof, a preferred range of the average of each of u, v, and w (the averages of v and w correspond to average substitution degrees) is the same as the preferred ranged of u, v, and w.

The sugar ester compound is commercially available as a commercial product manufactured by Tokyo Chemical Industry Co., Ltd., or manufactured by Aldrich, or may be synthesized by performing a known ester derivatization method (for example, a method described in Japanese Patent Application Laid-Open No. H8-245678) with commercially available carbohydrate.

The sugar ester compound has a number average molecular weight of preferably 200 to 2,000, more preferably 300 to 1,200, and particularly preferably 350 to 1,000.

Hereinafter, specific examples of the sugar ester preferably used in the present invention are described, but the present invention is not limited to the following aspects.

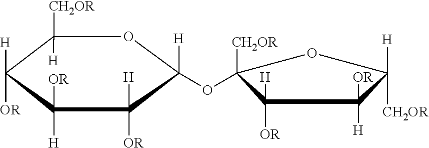

TABLE 1

| | Substituent 1 | | Substituent 2 | |
|---|---|---|---|---|
| Com- | | Substitution | | Substitution |
| pound | Kind | Degree | Kind | Degree |
| 101 | Benzoyl | 3 | — | — |
| 102 | Benzoyl | 4 | — | — |
| 103 | Benzoyl | 5 | — | — |
| 104 | Benzoyl | 6 | — | — |
| 105 | Phenylacetyl | 4 | — | — |
| 106 | Benzoyl | 4 | Acetyl | 1 |
| 107 | Benzoyl | 4 | Acetyl | 2 |

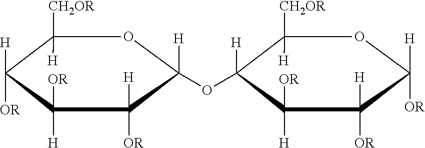

TABLE 2

| | Substituent 1 | | Substituent 2 | |
|---|---|---|---|---|
| Com- | | Substitution | | Substitution |
| pound | Kind | Degree | Kind | Degree |
| 201 | Benzoyl | 3 | — | — |
| 202 | Benzoyl | 4 | — | — |
| 203 | Benzoyl | 5 | — | — |
| 204 | Benzoyl | 6 | — | — |
| 205 | Phenylacetyl | 4 | — | — |
| 206 | Benzoyl | 4 | Acetyl | 1 |
| 207 | Benzoyl | 4 | Acetyl | 2 |

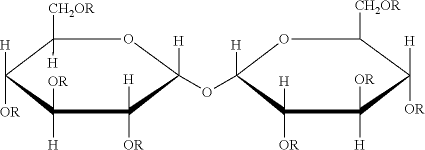

TABLE 3

| | Substituent 1 | | Substituent 2 | |
|---|---|---|---|---|
| Com- | | Substitution | | Substitution |
| pound | Kind | Degree | Kind | Degree |
| 301 | Benzoyl | 3 | — | — |
| 302 | Benzoyl | 4 | — | — |
| 303 | Benzoyl | 5 | — | — |
| 304 | Benzoyl | 6 | — | — |
| 305 | Phenylacetyl | 4 | — | — |
| 306 | Benzoyl | 4 | Acetyl | 1 |
| 307 | Benzoyl | 4 | Acetyl | 2 |

TABLE 4

| Sugar | | Substituent 1 | | Substituent 2 | |
|---|---|---|---|---|---|
| Ester | Mono- | | Substitution | | Substitution |
| Compound | saccharide | Kind | Degree | Kind | Degree |
| 401 | α-D-glucose | Benzoyl | 2 | — | — |
| 402 | α-D-glucose | Benzoyl | 3 | — | — |
| 403 | α-D-glucose | Benzoyl | 4 | — | — |
| 404 | β-D-glucose | Benzoyl | 3 | — | — |
| 405 | α-D-fructose | Benzoyl | 3 | — | — |
| 406 | β-D-fructose | Benzoyl | 3 | — | — |
| 407 | α-D-fructose | Benzoyl | 3 | Acetyl | 1 |
| 408 | α-D-fructose | Benzoyl | 3 | Acetyl | 2 |

The sugar ester compound is preferably contained in an amount of 0.16 g to 0.50 g, more preferably 0.22 g to 0.50 g, and particularly preferably 0.28 g to 0.40 g per 1 g of a solid component in the cellulose acylate film.

The number density of the aromatic group means a number density of an aromatic group derived from the aromatic group of the sugar ester compound, and is in a range of 0.90×10⁻³ mol/g to 5.00×10⁻³ mol/g, preferably 0.95 to 3.00×10⁻³ mol/g, more preferably 1.35 to 2.50×10⁻³ mol/g, and particularly preferably 1.45 to 2.50×10⁻³ mol/g.

It has been found that the number of the aromatic group has a strong causal relationship with Knoop hardness and pencil hardness. If the value of the number density is 0.90×10⁻³ mol/g or more, it is preferred in that the Knoop hardness and the pencil hardness arc enhanced. Furthermore, it is preferred from the viewpoint of the durability of the polarizing plate. Further, if the value is 5.00×10⁻³ mol/g or less, it is preferred in that a practical tearing strength is realized.

The cellulose acylate film may contain a plasticizer together with the cellulose acylate as a main component, in addition to the sugar ester compound. Particularly, a polycondensed oligomeric plasticizer of dicarboxylic acid and diol is preferred.

(UV Absorbent)

The cellulose acylate film related to the present invention preferably contains a UV absorbent together with the cellulose acylate as a main component. The UV absorbent contributes to improvement in durability of the film. Particularly, in an aspect of using the optical film of the present invention as a surface protective film for an image display device, addition of the UV absorbent is effective.

The UV absorbent which may be used in the present invention is not particularly limited. Any UV absorbent used in a conventional cellulose acylate film may be used. The UV absorbent may be exemplified with a compound as described in Japanese Patent Application Laid-Open No. 2006-184874. A polymer UV absorbent may be preferably used, and a polymer UV absorbent as described in Japanese Patent Application Laid-Open No. H6-148430 is particularly preferably used.

An amount of the UV absorbent used varies depending on the kind of the UV absorbent, conditions of use thereof, but the UV absorbent is more preferably contained in a ratio of 1% by mass to 3% by mass with respect to the cellulose acylate which is a main component.

The UV absorbent to be added is exemplified with UV-1 to 4, but not limited thereto.

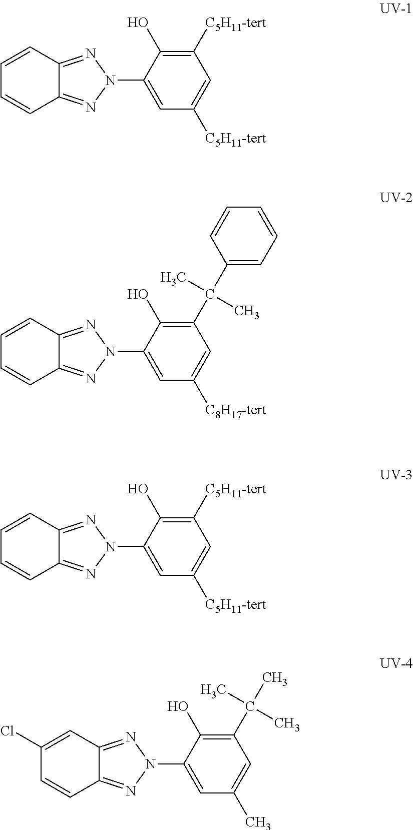

(Other Additives)

The cellulose acylate film may further contain at least one of other additives within a range not to impair the effects of the present invention. Examples of the other additives include a plasticizer other than sugar ester (for example, a phosphate ester-based plasticizer, ester-based plasticizer, a polycondensed oligomeric plasticizer, and the like). As described above, the polycondensed oligomeric plasticizer having an aromatic group is preferred in that the tensile elastic modulus is increased by the addition thereof, like the sugar ester. For available condensed oligomeric plasticizers having an aromatic group, those described in Japanese Patent Application Laid-Open No. 2010-242050, Japanese Patent Application Laid-Open No. 2006-64803 and the like may be used in the present invention.

(Method for Preparing Cellulose Acylate Film)

A method for preparing the cellulose acylate film is not particularly limited, but the film may be prepared using any known method. For example, the film may be formed using any one of a solution casting film forming method and a melt film forming method. From the viewpoint of improving a plane of the film, the cellulose acylate film is preferably prepared using the solution casting film forming method. Hereinafter, a case of using the solution casting film forming method will be exemplified, but the present invention is not limited to the solution casting film forming method. Further, for a case of using the melt film forming method, any known method may be used.

(Polymer Solution)

In the solution casting film forming method, a web is formed by using a polymer solution (cellulose acylate solution) containing the cellulose acylate, the sugar ester, and optionally various additives. Hereinafter, descriptions will be made on the polymer solution (hereinafter, appropriately referred to as a cellulose acylate solution) which may be used in the solution casting film forming method.

(Solvent)

The cellulose acylate used in the present invention is dissolved in a solvent to form a dope, which is in turn cast on a substrate to form a film. At this time, since there is a need to evaporate the solvent after extrusion or casting, a volatile solvent is preferably used.

Further, the solvent should neither react with a reactive metal compound or a catalyst, nor dissolve a substrate for casting. In addition, two or more kinds of solvents may be used in mixture.

Further, the cellulose acylate and a hydrolysable polycondensable reactive metal compound may be dissolved in separate solvents, respectively, and then, mixed later.

Here, an organic solvent having a good solubility for the cellulose acylate is referred to as a good solvent, and an organic solvent that expresses a main effect on dissolution and is used in a large amount is referred to as a main solvent or a primary solvent.

Examples of the good solvent may include ketones such as acetone, methyl ethyl ketone, cyclopentanone, and cylcohexanone, ethers such as teterahydrofurane (THF), 1,4-dioxane, 1,3-dioxolane, and 1,2-dimethoxyethane, esters such as methyl formate, ethyl formate, methyl acetate, ethyl acetate, amyl acetate, and γ-butyrolantone, as well as methyl cellosolve, dimethylimidazolinone, dimetylformamide, dimethylacetamide, acetonitrile, dimethylsulfoxide, sulfolane, nitroethane, methylene chloride, and methyl acetoacetate, and preferably 1,3-dioxolane, THF, methyl ethyl ketone, acetone, methyl acetate and methylene chloride.

The dope preferably contains, in addition to the organic solvent, 1% by mass to 40% by mass of alcohol having 1 to 4 carbon atoms.

Theses are used as gelation solvent which gelates a web (a doped film after casting a dope of the cellulose acylate on a support is referred to as a web) as the solvent starts to evaporate such that the ratio of the alcohol increases, and facilitates peeling from the metal support, or play a role to facilitate dissolution of the cellulose acylate in a non-chlorine-based organic solvent when the ratio is small or a role to suppress gelation, precipitation, and increase in viscosity of the reactive metal compound.

Examples of the alcohol having 1 to 4 carbon atoms may include methanol, ethanol, n-propanol, iso-propanol, n-butanol, sec-butanol, tert-butanol, and propylene glycol monomethyl ether.

Among them, ethanol is preferred in that the stability of the dope is excellent, the boiling point is relatively low, the dryness is good, and it is not toxic. Such an organic solvent has no solubility for the cellulose acylate when used alone, and is referred to as a poor solvent.

Since the cellulose acylate, which is a raw material in the present invention, contains a hydrogen-bonding functional group such as a hydroxyl group, ester, and ketone, it is preferred to contain 5% by mass to 30% by mass, more preferably 7% by mass to 25% by mass, and still more preferably 10% by mass to 20% by mass of alcohol in the whole solvent from the viewpoint of peeling load reduction from the casting support.

Further, in the present invention, containing small amount of water is also effective to enhance the viscocity of the solution or the film strength in a wet film state when dried, and for example, water may be contained in an amount of 0.1% by mass to 5% by mass, more preferably 0.1% by mass to 3% by mass, and particularly 0.2% by mass to 2% by mass based on the whole solvent.

Examples of combination of organic solvents preferably used as a solvent of the polymer solution in the present invention are discussed in Japanese Patent Application Laid-Open No. 2009-262551.

Further, if necessary, a non-halogen-based organic solvent may be used as a main solvent, and details thereof is described in Kokai Giho (Open Technical Report 2001-1745, issued on Mar. 15, 2001, Japan Institute of Invention and Innovation).

The concentration of the cellulose acylate in the polymer solution of the present invention is preferably 5% by mass to 40% by mass, more preferably 10% by mass to 30% by mass, and most preferably 15% by mass to 30% by mass.

The concentration of the cellulose acylate may be adjusted so as to be a desired concentration at a step of dissolving the cellulose acylate in the solvent. Further, a solution at a low concentration (for example, 4% by mass to 14% by mass) may be prepared in advance, and then, concentrated by evaporating the solvent. Furthermore, a solution at a low concentration may be prepared in advance, and the, diluted. In addition, the concentration of the cellulose acylate may be reduced by adding an additive.

The time to add an additive may be appropriately determined depending on the kind of the additive. For example, the sugar ester or the UV absorbent may be added to a dope after the UV absorbent is dissolved in an organic solvent such as alcohol, for example, methanol, ethanol, and butanol, methylene chloride, methyl acetate, acetone, and dioxolane, or a mixed solvent thereof, or may be added directly to the dope composition. Those that are not dissolved in the organic solvent, such as, for example, inorganic powders, are dispersed in the organic solvent and the cellulose acylate using a dissolver or a sand mill, and then, added to the dope.

As a solvent that satisfies the conditions and dissolves the cellulose acylate, which is a preferred polymer compound, at a high concentration, the most preferred solvent is a mixed solvent in which a ratio of methylene chloride:ethyl alcohol is 95:5 to 80:20. Or, a mixed solvent in which methyl acetate:ethyl alcohol is 60:40 to 95:5 is also preferably used.

(1) Dissolution Process

This is a process of dissolving cellulose acylate and additives in an organic solvent containing mainly a good solvent for the cellulose acylate to form a dope, or a process of mixing an additive solution in a cellulose acylate solution to form a dope.

The dissolution of cellulose acylate may be carried out by using various dissolution method such as a method which is performed at room temperature, a method which is performed below the boiling point of the main solvent, a method which is performed by pressurization above the boiling point of the main solvent, a method which is performed using a cooling dissolution method as described in Japanese Patent Application Laid-Open No. H9-95544, Japanese Patent Application Laid-Open No. H9-95557, or Japanese Patent Application Laid-Open No. H9-95538, a method which is performed at a high pressure as described in Japanese Patent Application Laid-Open No. H11-21379, and particularly preferably a method which is performed by pressurization above the boiling point of the main solvent.

(2) Casting Process

This is a process of casting a dope from a pressure die slit at a casting position on a metal support such as an endless metal belt that transfers indefinitely, for example, a stainless steel belt, or a rotating metal drum by feeding a dope through a liquid feeding pump (for example, a pressure metering gear pump).

Preferred is a pressure die which is easy to uniformize the film thickness because the slit shape in the inlet member of the die is able to be adjusted. The pressure die includes a coat hanger die and T die, both of which are preferably used. The surface of the metal support is configured as a mirror surface. In order to increase a film forming speed, two pressure dies may be provided on the metal support and overlaid by dividing the amount of the dope. Or, it is also preferred to obtain a multilayered film by a co-casting method for casting a plurality of dopes at the same time.

(3) Solvent Evaporation Process

This is a process of heating a web (which means a state where the solvent is contained still in a large amount before the cellulose acylate film becomes a finished product) on the metal support to evaporate the solvent until the web becomes peelable from the metal support.

In order to evaporate the solvent, there are a method of blowing a wind from the web side and/or a method of transferring heat by liquid on the rear surface of the metal support, and a method of transferring heat by radiant heat on the front and rear surfaces, but the rear surface liquid heat transfer method is preferred due to a good drying efficiency. In the case of the rear surface liquid heat transfer method, it is preferred to heat below the boiling point of the main solvent of the organic solvent used in the dope or an organic solvent having the lowest boiling point.

(4) Peeling Process

This is a process of peeling the web in which the solvent has been evaporated on the metal support, at a peeling position. The peeled web is sent to the next process. Further, if a residual solvent amount (the following equation) of the web is too large at the time of peeling, it is difficult to peel, or on the contrary, if peeling is performed after drying is performed too thoroughly on the metal support, a part of the web may be peeled in the middle.

Here, as a method of increasing the film forming speed (the film forming speed may be increased when peeling is performed while the residual solvent amount is as much as possible), there is a gel casting method. For example, there are a method of gelling after dope-casting by adding a poor solvent for the cellulose acylate during doping, a method of gelling by lowering the temperature of the metal support, and the like. By gelling on the metal support to enhance the strength of the film during the peeling, the film forming speed may be increased by advancing the peeling.

It is preferred to peel when the residual solvent amount of the wep on the metal support during the peeling is in a range of 5% by mass to 150% by mass depending on the intensity of the drying condition, the length of the metal support, and the like, but when the peeling is performed at a time point when the residual solvent amount is more, the residual solvent amount during the peeling is determined in consideration of a balance between an economical speed and a quality. In the present invention, the temperature at the peeling position on the metal support is preferably −50° C. to 40° C., more preferably 10° C. to 40° C., and most preferably 15° C. to 30° C.

Further, the residual solvent amount of the wep at the peeling position is preferably set to 10% by mass to 150% by mass, and more preferably 10% by mass to 120% by mass.

The residual solvent amount may be represented by the following equation.

Residual solvent amount (% by mass)=[(M−N)/N]×100

Here, M represents a mass of the web at an arbitrary time point, and N represents a mass after drying one having mass M at 110° C. for 3 hours.

(5) Drying or Heat Treatment Process, Stretching Process

After the peeling process, the web is preferably dried using a drying apparatus in which the web is conveyed by alternately passing through a plurality of rolls disposed in the drying apparatus, and/or a tenter apparatus in which the web is conveyed by clipping both ends of the web with a clips.

In a case where heat treatment is performed in the present invention, the heat treatment temperature is lower than Tg−5° C., preferably Tg−20° C. or higher and lower than Tg−5° C., and more preferably Tg−15° C. or higher and lower than Tg−5° C.

Further, the heat treatment time is preferably 30 minutes or less, more preferably 20 minutes or less, and particularly preferably about 10 minutes.

A means for drying and heat treatment is generally to blow hot air to both surfaces of the web, but there is also a means to heat using microwaves instead of hot air. The temperature, the air amount, and the time vary depending on the solvents used, and the conditions thereof may be appropriately selected depending on the kind and combination of the solvents used.

Stretching in the film conveying direction MD may be performed, and the stretching ratio thereof is preferably 0% to 20%, more preferably 0% to 15%, and particularly 0% to 10%. The stretching ratio (elongation) of the web during the stretching may be achieved by a circumferential speed difference between the metal support speed and the stripping speed (stripping roll draw). For example, when an apparatus provided with two nip rolls is used, the film may be desirably stretched in the conveying direction (longitudinal direction) by making the rotational speed of the nip roll at the outlet side faster than the rotational speed of the nip roll at the inlet side. By performing such stretching, the tensile elastic modulus in MD may be enhanced.

Further, the “stretching ratio (%)” as used herein may be obtained by the following equation.

Stretching ratio (%)=100×{(Length after stretching)−(Length before stretching)}/Length before stretching

Further, stretching in a direction TD orthogonal to the film conveying direction may also be performed, and the stretching ratio thereof is preferably 0% to 60%, more preferably 10% to 50%, and particularly preferably 20% to 50%.

Further, in the present invention, as a method of stretching in the direction TD orthogonal to the film conveying direction, it is preferred to stretch using a tenter apparatus.

When biaxially stretched, a desired retardation value may be obtained by relaxing, for example, 0.8 to 1.0 times in the longitudinal direction. The stretching ratio is set depending on a desired optical characteristic. When the cellulose acylate film is prepared, monoaxial stretching may be performed in a longer direction. By performing such stretching, the tensile elastic modulus in TD may be enhanced.

The temperature when stretching is preferably Tg or lower because the tensile elastic modulus in the stretching direction increases. The stretching temperature is preferably Tg−50° C. to Tg, and more preferably Tg−30° C. to Tg−5° C. Meanwhile, when stretched under the temperature condition, the tensile elastic modulus in the stretching direction increases while the tensile elastic modulus in the direction orthogonal thereto decreases. Accordingly, in order to increase the tensile elastic moduli in both MD and TD, it is preferred to perform stretching in both directions, that is, biaxial stretching.

Further, drying may be performed after the stretching process. When drying is performed after the stretching process, a drying temperature, a drying air amount, and a drying time vary depending on the solvents used, and the drying conditions may be appropriately selected depending on the kind and combination of the solvents used. In the present invention, it is preferred that the drying temperature after the stretching process is lower than the stretching temperature of the stretching process, from the viewpoint of increasing the front contrast when the film is incorporated into a liquid crystal display device.

(6) Winding

The film thus obtained is preferably wound in a length of 100 m to 10,000 m, more preferably 500 m to 7,000 m, and still more preferably 1,000 m to 6,000 m per roll. The width of the film is preferably 0.5 m to 5.0 in, more preferably 1.0 m to 3.0 m, and still more preferably 1.0 m to 2.5 m. When winding, it is preferred to impart knurling to at least one end, the width of the knurling is preferably 3 mm to 50 mm, and more preferably 5 mm to 30 mm, and the height is preferably 0.5 μm to 500 μm, and more preferably 1 μm to 200 μm. This may be either one-side pushing or both-side pushing.

The cellulose acylate film may be obtained by winding the web thus obtained.

(Layer Configuration)

The cellulose acylate film used in the present invention may be a monolayered film or may have a laminate structure of two or more layers. For example, as a laminate structure composed of two layers, that is, a core layer and a skin layer, an aspect of film formed by a co-casting is also preferred.

[Hardcoat Layer]

As a preferred aspect, the cellulose acylate film of the present invention has a hardcoat layer having a thickness of 0.1 μm to 6 μm (preferably, 3 μm to 6 μm). By having such a thin hardcoat layer within the above-mentioned range, it is possible to obtain an optical film including a hardcoat layer in which physical properties such as suppression of brittleness or curl, light weighting, and reduction in production cost are achieved. Further, by using the cellulose acylate film of the present invention as a base film, the pencil hardness may be remarkably enhanced.

Further, by curing a curable composition of the hardcoat layer on the cellulose acylate film (base) of the present invention, the optical film may be excellent in adhesion between the hardcoat layer and the base film.

For the purpose of adding other functions, other functional layers may be laminated on the hardcoat layer. Specifically, it is an anti-reflection layer or an anti-fouling layer.

Further, by adding a filler or an additive to the hardcoat layer, mechanical, electrical, optical, or physical performances or chemical performances such as water repellency or oil repellency may be imparted to the hardcoat layer itself.

The hardcoat layer is preferably formed by curing a curable composition. The curable composition is preferably prepared as a liquid coating composition. As an example, the coating composition contains a monomer or oligomer for a matrix forming binder, polymers and an organic solvent. The hardcoat layer may be formed by curing the coating composition after coated thereon. A crosslinking reaction or polymerization reaction may he used for the curing.

(Monomer or Oligomer for Matrix Forming Binder)

Examples of an available monomer or oligomer for a matrix forming binder include an ionized radiation curable polyfunctional monomer and polyfunctional oligomer. The polyfunctional monomer or polyfunctional oligomer is preferably crosslinkable or polymerizable monomers. The functional group of the ionized radiation curable polyfunctional monomer or the polyfunctional oligomer is preferably a photopolymerizable, electron beam polymerizable, or radiation polymerizable functional group, and among them, the photopolymerizable functional group is preferred.

Examples of the photopolymerizable functional group include unsaturated polymerizable functional groups such as a (meth)acryloyl group, a vinyl group, a styryl group, and an allyl group, or ring-opening polymerization type polymerizable functional groups such as epoxy-based compounds, and among them, a (meth)acryloyl group is preferred.

Specific examples of the photopolymerizable polyfunctional monomer having a photopolymerizable functional group include (meth)acrylate diesters of alkylene glycol, such as neopentyl glycol acrylate, 1,6-hexanediol (meth)acrylate and propylene glycol di(meth)acrylate; (meth)acrylate diesters of polyoxyalkylene glycol, such as triethylene glycol di(meth)acrylate, dipropylene glycol di(meth)acrylate, polyethylene glycol di(meth)acrylate and polypropylene glycol di(meth)acrylate; (meth)acrylate diesters of polyhydric alcohol, such as pentaerythritol di(meth)acrylate; and (meth)acrylate diesters of ethylene oxide or propylene oxide adduct, such as 2,2-bis{4-(acryloxydiethoxy)phenyl}propane and 2-2-bis{4-(acryloxypolypropoxy)phenyl}propane; and the like.

Further, urethane(meth)acrylates, polyester(meth)acrylates, isocyanurate acrylates and epoxy(meth)acrylates may also be preferably used as the photopolymerizable polyfunctional monomer.

Among those described above, esters of a polyhydric alcohol and (meth)acrylic acid are preferred, and polyfunctional monomers having three or more (meth)acryloyl groups in one molecule thereof are more preferred.

Specific examples thereof include (di)pentaerythritol tri(meth)acrylate, (di)pentaerythritol tetra(meth)acrylate, (di)pentaerythritol penta(meth)acrylate, (di)pentaerythritol hexa(meth)acrylate, tripentaerythritol triacrylate, tripentaerythritol hexatriacrylate, trimethylolpropane tri(meth)acrylate, trimethylolethane tri(meth)acrylate, ditrimethylolpropane tetra(meth)acrylate, EO-modified trimethylolpropane tri(meth)acrylate, PO-modified trimethylolpropane tri(meth)acrylate, EO-modified phosphoric acid tri(meth)acrylate, 1,2,4-cyclohexane tetra(meth)acrylate, pentaglycerol triacrylate, 1,2,3-cyclohexane tetramethacrylate, polyester polyacrylate, caprol actone-modified tris(acryloxyethyl)isocyanurate and the like.

In the present specification, “(meth)acrylate”, “(meth)acrylic acid” and “(meth)acryloyl” mean “acrylate or methacrylate”, acrylic acid or methacrylic acid” and “acryloyl or methacryloyl”, respectively.

For resins having three or more (meth)acryloyl groups, examples thereof also include polyester resins having a relatively low molecular weight, as well as polyether resins, acrylic resins, epoxy resins, urethane resins, alkyd resins, spiroacetal resins, polybutadiene resins, polythiol polyene resins, oligomers or prepolymers of polyfunctional compounds such as polyhydric alcohols, and the like.

For specific compounds of polyfunctional acrylate-based compounds having three or more (meth)acryloyl groups, reference may be made to [0096] of Japanese Patent Application Laid-Open No. 2007-256844 and the like.

Examples of urethane acrylates include urethane acrylate-based compounds obtained by reacting hydroxyl group-containing compounds such as alcohol, polyol and/or hydroxyl group-containing acrylate with isocyanates, or if necessary, esterifying the polyurethane compound obtained through the reaction with (meth)acrylic acid.

For specific examples of specific compounds, reference may be made to [0017] of Japanese Patent Application Laid-Open No. 2007-256844 and the like.

Use of isocyanurate acrylates is preferred because the curling may be reduced. Examples of isocyanurate acrylates include isocyanurate diacrylates and isocyanurate triacrylates; and for specific examples of those compounds, reference may be made to [0018] to [0021] of Japanese Patent Application Laid-Open No. 2007-256844 and the like.

An epoxy-based compound may be used in the hardcoat layer for reducing the shrinkage of the layer through curing. As the epoxy group-containing monomers to constitute the compound, usable are monomers having two or more epoxy groups in one molecule thereof, and examples of those monomers include epoxy-based monomers described in Japanese Patent Application Laid-Open Nos. 2004-264563, 2004-264564, 2005-37737, 2005-37738, 2005-140862, 2005-140862, 2005-140863, 2002-322430 and the like. In addition, compounds having both epoxy and acrylic functional groups such as glycidyl(meth)acrylate are also preferably used.

(Curable Composition)

An example of a curable composition which may he used in formation of the hardcoat layer is a curable composition containing an acrylate-based compound. The curable composition preferably contains a photo radical polymerization initiator or thermal radical polymerization initiator together with the acrylate-based compound, and may further contain a filler, a coating aid, or other additives as necessary. Curing of the curable composition may be performed by undergoing a polymerization reaction by irradiation with ionized radiation or heating in the presence of a photo radical polymerization initiator or thermal radical polymerization initiator. Both ionized radiation curing and thermal curing may be preformed. For the photo and thermal radical polymerization initiators, any commercially available compounds may be used, and they are described in “The latest UV curing technology” (p. 159, issued by Kosusuki Kazuhiro; published by Technical Information Institute Co. Ltd., 1991), or in the catalog of Ciba Specialty Chemicals Co., Ltd.

The curable composition is preferably prepared as a coating solution. The coating solution may be prepared such that the components are dissolved and/or dispersed in the organic solvent.

(Properties of Hardcoat Layer)

The hardcoat layer is preferably excellent in scratch resistance. Specifically, when a pencil hardness test as an index of scratch resistance is performed, it is preferred to achieve that 3H or higher is achieved, and it is more preferred that 4H or higher is achieved in any direction of MD and TD.

Further, unevenness may be formed on the surface of the hardcoat layer using a method known in the art so as to have an antiglare function.

[Use of Optical Film]

The optical film of the present invention is useful for various applications such as a polarizing plate protective film, and a surface protective film disposed on an image display surface. In order to exert functions suitable for the respective applications, the optical film may have other layers in addition to the cellulose acylate film and the hardcoat layer. For example, the optical film may have an antireflection layer, an antistatic layer, or an antifouling layer.

2. Polarizing Plate

The present invention also relates to a polarizing plate having the optical film of the present invention and a polarizer.

The polarizing plate may be fabricated by a general method. For example, the polarizing plate may be fabricated by adhering the rear surface (a surface on which the hardcoat layer is not formed) of the cellulose acylate film that is the optical film of the present invention, and a polarizer. The adhesion surface of the cellulose acylate is preferably subjected to saponification. Further, an aqueous completely saponified polyvinyl alcohol solution may be used for adhesion.

For the polarizer, any conventionally known polarizer may be used. For example, a polarizer obtained by treating a film, which is composed of a hydrophilic polymer such as an ethylene-modified polyvinyl alcohol having a polyvinyl alcohol or ethylene unit of 1% by mol to 4% by mol, a polymerization degree of 2,000 to 4,000 and a saponification degree of 99.0% by mol to 99.99% by mol with a dichroic dye such as iodine and stretching the film, or a polarizer obtained by treating a plastic film such as vinyl chloride and orienting the film, is used.

A polarizer having a film thickness of 5 μm to 30 μm is preferably used. The polarizer thus obtained is adhered to the polarizing plate protective film.

The protective film may also be adhered on a surface of the polarizer to which the optical film is not adhered. The protective film is not particularly limited with respect to any of optical properties and materials. An optically isotropic film may be used, or an optically anisotripic retardation film may be used. In an aspect in which the polarizing plate of the present invention is used for a liquid crystal display device, the preferred cellulose acylate film of the present invention is generally disposed outside of the display side. Accordingly, since another protective film is disposed between the polarizer and a liquid crystal cell, a retardation film which contributes to optical compensation of birefringence of the liquid crystal cell may be used as another protective film. As another protective film, a cellulose acylate film, a cyclic polyolefin-based film, a polycarbonate-based film and the like may be used.

The polarizing plate protective film used at the surface side of the display device preferably has an antireflection layer, an antistatic layer, and an antifouling layer, as well as an antiglare layer or a clear hardcoat layer, in addition to the hardcoat layer.

Further, in fabricating the polarizing plate, in a case where the cellulose acylate film provided in the optical film of the present invention has an in-plane slow axis, the in-plane slow axis and a transmission axis of the polarizer are preferably adhered to be parallel with or orthogonal to each other.

3. Image Display Device

The present invention also relates to an image display device having the optical film of the present invention. The function of the optical film of the present invention in the image display device is not particularly limited. An example thereof is a surface protective film which is disposed outside of the display side.

The image display device is also not particularly limited, and the image display device may be a liquid crystal display device including a liquid crystal cell, an organic EL image display device including an organic EL layer, or a plasma display device. Since the optical film of the present invention includes a cellulose acylate film, the optical film has good adhesibility with a polarizer, and thus is suitable for use in a liquid crystal display device including a polarizing plate as an essential member.

[Liquid Crystal Display Device]

The liquid crystal display device is characterized by having the polarizing plate of the present invention. The polarizing plate of the present invention is preferably a polarizing plate which is disposed at the display side, and the optical film of the present invention is preferably disposed outside the display side. With respect to the other configurations, any configuration of a known liquid crystal display device may be adopted. The mode thereof is also not particularly limited, and the liquid crystal display device may be configured as a liquid crystal display device of various display modes such as TN (twisted nematic), IPS (in-plane switching), FLC (ferroelectric liquid crystal), AFLC (anti-ferroelectric liquid crystal), OCB (optically compensatory bend), STN (supper twisted nematic), VA (vertically aligned), and HAN (hybrid aligned nematic).

### EXAMPLES

<<1>> Preparation and Evaluation of Optical Film

A film was prepared with materials and a preparation method as follows.

(Preparation of Polymer Solution)

1] Cellulose Acylate

Cellulose acylate having an acetyl substitution degree of 2.88 (acetyl cellulose) was used. The acetyl cellulose, which is a raw material, was heated to 120° C. to dryness to set the water content to 0.5% by mass. The nuber average molecular weight of the acetyl cellulose used was 96,000.

2] Solvent

A mixed solvent of dichloromethane/methanol=87/13 (mass ratio) was used. The water content was 0.2% by mass.

3] Sugar Ester Compound

Sugar ester compounds listed in Table 5 were used.

TABLE 5

| Sugar Ester | Sugar | Substituent | |
|---|---|---|---|
| Compound | Structure | Kind | Substitution Degree |
| C-1 | Sucrose | Benzoyl | 5.6 |
| C-2 | Sucrose | Benzoyl | 4.0 |
| C-3 | Sucrose | Benzoyl | 3.0 |
| C-4 | Sucrose | Acetyl | 8.0 |

4] Composition of Polymer Solution

The following composition was introduced into a mixing tank, and each component was dissolved with stirring to prepare a polymer solution.

(Amount of each component added)

| Cellulose acylate | 100 | parts by mass |
|---|---|---|
| Mixed solvent | 500 | parts by mass |
| UV absorbent UV-1 | 2.5 | parts by mass |
| Sugar ester (compound listed in Table 5) | Amount shown in Table 6 | |
| Silicon dioxide particles | 0.1 | parts by mass |

(particle size: 20 nm, Mohs harness: about 7)

UV absorbent

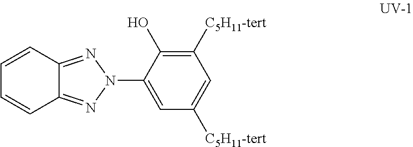

(Fabrication of Film)

The polymer solution was filtered by a filter paper having an average hole diameter of 34 μm and a sintered metal filter having an average hole diameter of 10 μm, and then, cast using a band caster. When the residual solvent amount reached 30%, a film was peeled from the band, and the film was fabricated by appropriately adjusting the drying temperature and time such that the residual solvent amount of the film became 0.2% or less. The film thickness of the film obtained was listed in Table 6.

TABLE 6

| | Example | | | | | | Comparative Example | | |
|---|---|---|---|---|---|---|---|---|---|
| No | 1 | 2 | 3 | 4 | 5 | 6 | 7 | 8 | 9 |
| Kind of Sugar Ester | C-1 | C-1 | C-1 | C-1 | C-2 | C-3 | C-4 | C-1 | C-1 |
| Kind of Aromatic group | Bz | Bz | Bz | Bz | Bz | Bz | None | Bz | Bz |
| Average Substitution Degree | 5.6 | 5.6 | 5.6 | 5.6 | 4.0 | 3.0 | — | 5.6 | 5.6 |
| of Aromoatic group (A) | | | | | | | | | |
| Kind of Aliphatic group | None | None | None | None | None | None | Ac | None | None |
| Average Substitution Degree | — | — | — | — | — | — | 8.0 | — | — |
| of Aliphatic group (B) | | | | | | | | | |
| Unsubstition Degree | 2.4 | 2.4 | 2.4 | 2.4 | 4.0 | 5.0 | — | 2.4 | 2.4 |
| (OH group) | | | | | | | | | |
| Molecular Weight (M) | 925.3 | 925.3 | 925.3 | 925.3 | 758.7 | 654.6 | 678.6 | 925.3 | 925.3 |
| Addition Amount | 20 | 30 | 40 | 50 | 40 | 50 | 20 | 5 | 5 |
| (part by mass) | | | | | | | | | |
| Solid Amount regarded as | 122.6 | 132.6 | 142.6 | 152.6 | 142.6 | 152.6 | 122.6 | 107.6 | 107.6 |
| Base (part by mass) | | | | | | | | | |
| Sugar Ester Compound [g]/ | 0.163 | 0.226 | 0.281 | 0.328 | 0.281 | 0.328 | 0.163 | 0.046 | 0.046 |
| Solid 1 g (D) | | | | | | | | | |
| Number Density of Aromatic | 0.99 | 1.37 | 1.70 | 1.99 | 1.48 | 1.50 | 0.00 | 0.28 | 0.28 |
| Group [10⁻³ mol/g film solid] | | | | | | | | | |
| Film Thickness [μm] | 25 | 25 | 25 | 25 | 25 | 25 | 25 | 25 | 42 |
| Knoop Hardness [N/mm²] | 240 | 248 | 255 | 260 | 250 | 251 | 218 | 224 | 224 |
| Evaluation Value of | 3 | 2 | 1 | 1 | 1 | 1 | 56 | 10 | 5 |
| Durability of Polarizing Plate | | | | | | | | | |
| Pencil Hardness | 2H | 2H | 2H | 2H | 2H | 2H | H | H | 2H |

Abbreviation
Bz: Benzyl
Ac: Acetyl

(Knoop Hardness)

A Knoop hardness was obtained from a relationship between a load and a maximum indentation depth obtained by pressing a diamond indentor onto main surfaces of the cellulose acylate films of Examples of the present invention and Comparative Examples using HM2000 Type hardness tester manufactured by Fischer Instruments under conditions including a maximum indentation load of 50 mN or 100 mN, an indentation speed of 10 sec., and a creep of 5 sec.

The Knoop hardness of the cellulose acylate film of the present invention is preferably 240 N/mm², and more preferably 245 N/mm². When the Knoop hardness is 240 N/mm² or more, the pencil hardness is raised by one rank.

(Evaluation of Pencil Harness)

An evaluation of the pencil hardness described in JIS K5400 was performed. The cellulose acylate films of Examples and Comparative Examples were humidity-controlled at temperature of 25° C. and humidity of 60% RH for 2 hours, and then, evalusted with the following determination using test pencils of F to 5H as defined in JISS 6006 under a load of 4.9 N, and the highest hardness, which is OK, was used as an evaluation value. By evaluating with the following determination, the highest hardness, which is OK, was used as an evaluation value.

OK: from no scar to two scars in evaluation of n=5

NG: three or more scars in evaluation of n=5

<<2>> Fabrication and Evaluation of Polarizing Plate

(Fabrication of Polarizing Plate)

1] Saponification of Film

The respective films fabricated in Examples and Comparative Examples and FUJITAC TD40UC (manufactured by Fujifilm Co., Ltd.) were immersed in 4.5 mol/L of an aqueous sodium oxide solution (saponification solution) the temperature of which was adjusted to 37° C., for 1 minute. Thereafter, the films were washed with water, immersed in 0.05 mol/L of an aqueous sulfuric acid solution for 30 seconds, and then, further allowed to pass through the water bath. Then, the films were subjected to dehydration by an air knife repeatedly three times, dropped into water, and then, dried by allowing them to stay in a drying zone of 70° C. for 15 seconds, thereby fabricating saponified films.

2] Fabrication of Polarizing Film

A polarizing film having a thickness of 20 μm was fabricated by imparting a circumferential speed difference between two pairs of nip rolls and stretching in the length direction thereof in accordance with Example 1 of Japanese Patent Application Laid-Open No. 2001-141926.

3] Adhesion

A polarizing plate was fabricated by selecting the polarizing film thus obtained and two sheets of the saponified films such that the polarizing film is sandwiched therebetween, and adhering them using a 3% aqueous solution of PVA (PVA-117H; manufactured by KURARAY CO., LTD.) as an adhesive by roll-to-roll such that the polarizing axis and the length direction of the films are orthogonal to each other. Here, one film of the polarizing film was a saponified film selected from the group of films listed in Table 6, and the other film was a saponified FUJITAC TD40UC film.

4] Evaluation of Durability of Polarizing Plate

For the polarizing plate as fabricated above, two sets of samples (about 5 cm×5 cm) were fabricated, in which an opposite side to the side of each of the cellulose acylate films of Examples and Comparative Examples was adhered onto a glass plate using an adhesive. They were disposed in a crossed nicol, an orthogonal transmissivity thereof was measured at 410 mn using VAP-7070 (manufactured by JASCO Corporation), and an average value of 10 measurements were used as an orthogonal transmissivity (%).

Then, an orthogonal transmissivity after stored at 60° C. and 95% RH for 1,000 hours were measured by the above-mentioned method. The evaluation value of the durability of the polarizing plate is defined as follows.

Evaluation value of durability of polarizing plate=[Orthogonal transmissivity after lapse of time (%)−Orthogonal transmissivity before lapse of time (%)]/Orthogonal transmissivity before lapse of time (%)

The result of the above evaluation value was listed as the durability of the polarizing plate in Table 6.

The evaluation value is preferably as small as possible, and it is understood that the cellulose acylate films of Examples of the present invention have more excellent durability of the polarizing plate than Comparative Example C-1 having a film thickness of 42 μm.

### INDUSTRIAL APPLICABILITY

According to the optical film of the present invention, both thinning and hardness (Knoop hardness and pencil hardness) of the protective film for the polarizing plate can be achieved, and durability of the polarizing plate can be improved.

Although the present invention has been described in detail with reference to specific embodiments, it is obvious to those skilled in the art that various changes or modifications can be made without departing from the spirit and scope of the present invention. The present application is based on Japanese Patent Application (Patent application No. 2012-217536) filed on Sep. 28, 2012, and Japanese Patent Application (Patent application No. 2013-175677) filed on Aug. 27, 2013, the contents of which are incorporated herein by reference.

What is claimed is:

1. An optical film which is a cellulose acylate film comprising:
a cellulose acylate; and
a sugar ester compound containing at least one aromatic group,
wherein the cellulose acylate film has a thickness of 15 μm to 35 μm, and a number density of the aromatic group of the sugar ester compound is 0.90×10⁻³ mol or more and 5.00×10⁻³ mol or less per 1 g of a solid component in the cellulose acylate film.

2. The optical film according to claim 1,
wherein a Knoop hardness is 240 N/mm² or more.

3. The optical film according to claim 2,
wherein the sugar ester compound containing at least one aromatic group is represented by formula (1):
(OH)ᵤ-G-(O—R¹)ᵥ(O—R²)_{w} Formula (1)
wherein G represents a sugar residue,
R¹ represents a monovalent aromatic group, and R¹ may include a plurality of species of aromatic groups when a plurality of R¹'s is present,
R² represents a monovalent aliphatic group, and R² may include a plurality of species of aliphatic groups when a plurality of R²'s is present, and
u, v, and w each independently represent an integer, u+v+w is the same as a number of hydroxyl groups when G is a unsubstituted sugar having a cyclic acetal structure, and u and w may be zero, but v is 1 or more.

4. The optical film according to claim 3,
wherein R¹ represents an acyl group having an aromatic ring.

5. The optical film according to claim 4,
wherein R¹ represents a benzoyl group.

6. The optical film according to claim 3,
wherein R² represents an aliphatic acyl group.

7. The optical film according to claim 6,
wherein R² represents an acetyl group.

8. The optical film according to claim 3,
wherein G is a monosaccharide residue, and v is from 2 to 4.

9. The optical film according to of claim 3,
wherein G is a disaccharide residue, and v is from 2 to 7.

10. The optical film according to claim 2.
wherein an amount of the sugar ester compound is 0.16 g to 0.50 g per 1 g of a solid component in the cellulose acylate film.

11. The optical film according to claim 10,
wherein an amount of the sugar ester compound is 0.28 g to 0.40 g per 1 g of a solid component in the cellulose acylate film.

12. The optical film according to claim 2, further comprising an ultraviolet ray absorbent.

13. A polarizing plate comprising at least one sheet of the optical film according to claim 1.

14. A liquid crystal display device comprising the polarizing plate according to claim 13.
